(19) United States
(12) Patent Application Publication
(10) Pub. No.: US 2007/0172268 A1
(43) Pub. Date: Jul. 26, 2007

(54) Printing device

(76) Inventors: Bernd Schultheis, Schwabenheim (DE); Holger Kobrich, Florsheim (DE); Marcel Albus, Aichwald (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 10/519,766

(22) PCT Filed: Jun. 11, 2003
(86) PCT No.: PCT/EP03/06090

§ 371 Date: Jul. 28, 2006

(30) Foreign Application Priority Data
Jun. 22, 2002 (DE) 102 27 953.5

(51) Int. Cl. G03G 15/16

(52) U.S. Cl. 399/307

(57) ABSTRACT

A printing device having an electrophotographic printing group, to which a transfer medium for transferring a toner powder onto a substrate in a transfer zone is allocated. The substrate can be conducted through the transfer zone by a transport system and thermal energy can be introduced into the substrate by one or more heating elements. To improve the quality of the printed image, a cooling device is allocated to the transfer medium, and the device withdraws thermal energy from the transfer medium.

### BACKGROUND OF THE INVENTION

1. Field of the Invention

This invention relates to a printing device with an electro-photographic print unit, to which a transfer medium for transferring a toner powder to a substrate in a transfer zone is assigned, wherein the substrate can be conducted through the transfer zone by a transport system, and heat energy can be introduced into the substrate by one or several heating elements.

2. Discussion of Related Art

A printing device is known from U.S. Pat. No. 5,988,068. There, an endlessly revolving belt is assigned to an electro-photographic print unit as the transfer medium. A photoconductor rolls off on the belt for transferring an image made of toner powder. The toner image can be applied to a substrate. The substrate is moved beyond the transfer medium by a transport system. The transfer medium rolls off the substrate surface to be imprinted. For improving the toner transfer, U.S. Pat. No. 5,988,068 proposes the employment of two heating elements. The first heating element heats the substrate to a temperature higher than 60° C. The second heating element acts on the transfer medium at a temperature higher than 100° C.

This arrangement is disadvantageous because with printing with ceramic toners, residue from the toner adheres to the transfer medium which, because of the doughy consistency, is hard to remove at this temperature, or cannot be completely removed. Also, during constant operation, heat is introduced into the electro-photographic print unit via the transfer medium which results in lesser image quality.

### SUMMARY OF THE INVENTION

It is one object of this invention to provide a printing device of the type mentioned above but which has an improved toner transfer from the transfer medium to the substrate.

This object is achieved with a cooling device assigned to the transfer medium, which removes heat from the transfer medium. Because of the cooling of the transfer medium, the toner powder does not adhere to the surface of the transfer medium after transfer to the substrate is completed, but instead is released almost completely during the transfer. The introduction of heat into the print unit, in particular at the sensitive photoconductor, is also prevented by the cooling, or is at least minimized to an acceptable degree.

In accordance with one embodiment of this invention, near the transfer zone formed with the substrate, the transfer medium has a lower temperature at least in the area of or near the contact face, than the surface of the substrate. It is assured that the flow of heat can occur at most from the substrate to the transfer medium. Then the cooling device removes this heat in a controlled manner, at least in the greatest part.

In accordance with this invention, the cooling device cools the temperature of the transfer medium to a temperature≦60° C. The temperature preferably is less than 40° C. At these temperatures the transfer medium is not heated, even during constant operation, so that the toner powder reacts with the surface of the transfer medium. The toner transfer can also be assisted if the toner transfer in the transfer zone can be affected by one or several coronas during which electrostatic forces act on the toner powder. For example, it is possible to arrange coronas over large areas upstream and/or downstream of the transfer zone. These then charge the substrate. Alternatively, or additionally, the substrate can also be placed on a conductive base. In contrast to negatively charged toners, the toners are then positively charged. With positively charged toners then correspondingly negatively the charge voltages can be reduced in an advantageous manner so that negative field effects, such as with an exclusive toner transfer created by electrostatic fields, no longer occur.

An additional improvement of the toner transfer can be achieved if on a surface which receives the toner powder the transfer medium has an anti-adhesive layer with a surface energy within the range of 15 mN/m to 30 mN/m.

It is possible to use a Teflon coating within the range of 18 to 20 mN/m. In this case the anti-adhesive layer should have a layer thickness in a range between 1 and 100 μm, preferably 5 to 50 μm. A particularly effective heating of the substrate can occur if the substrate can be charged with heat energy by a heating element designed as an infrared radiator and/or a hot air blower and/or by the application of a flame. The substrate should be heated in a temperature range between 80° C. and 200° C. In a preferred manner, the surface temperature of the substrate in the coating area is set to more than 100° C. to 170° C. In this case, the temperature should be set as a function of the toner used. Tests with ceramic toners having a solids component (pigments, glass frit) of 50 to 70% show that a surface temperature of the substrate of 120° C. to 150° C. is particularly advantageous. Following the conclusion of the transfer, the toner powder should melt onto the substrate. If the toner powder is completely melted, a subsequent fixation can possibly be omitted.

On one hand, the print medium can consist of a matrix of thermoplastic material, into which organic or inorganic color pigments and/or glassy paste particles can be introduced for coloration.

In another case, the plastic matrix is of a mixture of hardening and binder resins, or of polymers which, at temperatures>100° C., are reacted to form thermosetting, such as spatially cross-linked, structures, into which again organic or inorganic color pigments can be introduced for coloration.

Also, other additives can be contained in it, such as conductive particles or particles of mechanically resistant material, for example, which later result in an electrically conductive coating or a protective layer against scratches, for example.

Matched to the substrate to be imprinted, it may be necessary to maintain the substrate temperature as low as possible, particularly in connection with temperature-sensitive plastic substrates or with glass which is less resistant to temperature changes. In this case it is necessary to adapt the plastic matrix of the print media so that the softening point of the matrix is also lowered. This is of particular interest when, in the case of additives such as ceramic pigments or glass paste particles, the softening temperature rises with an increased proportion of solids in the plastic matrix.

Some examples of toners with ceramic color and glass paste additions include:
Toner 1: Proportion of solids 44 wt-% and Softening temperature of 98° C.;
Toner 2: Proportion of solids 58 wt-% and Softening temperature of 104° C.;
Toner 3: Proportion of solids 71 wt-% and Softening temperature of 113° C.

A reduction of the softening temperature in case of an increased proportion of solids is provided, on the one hand, by adding polymer additives, such as wax, or by using a different low-melting plastic matrix.

The indicated softening temperatures relate to measurements by a Shimazu viscosity measuring device Type CFT-500 c.

Measuring conditions:

| | | |
|---|---|---|
| Supported weight | 10 | kg |
| Nozzle diameter | 0.5 | mm |
| Nozzle length | 1 | mm |
| Plunger surface | 1 | cm² |
| Start temperature | 80° | C. |
| Heating rate | 3 | k/min. |

To achieve a control of the substrate temperature, a temperature sensor can be assigned to the substrate, and the heating element and/or the transport system can be controlled by a control device as a function of the signal emitted by the temperature sensor.

In this case the temperature can be regulated by acting on the transport system via the retention time of the substrate in the heating zone, or via the speed of its passage.

Regulation preferably occurs when the substrate enters the transfer zone at a constant surface temperature. During the transfer, the substrate surface should be evenly heated.

To achieve an effective heat regulation of the transfer medium, one or several liquid-cooled contact rollers of the cooling device roll off on the transfer medium and/or a climate-controlled air flow is directed onto the surface of the transfer medium.

It is also possible for the transfer medium to be a transfer roller which contains at least a portion of the cooling device. Thus the cooling device can also contain one or several Peltier elements. Alternatively or additionally, the transfer roller can also be water-cooled or air-cooled.

If the cooling device removes heat energy from the transfer medium downstream of the transfer zone and upstream of the photoconductor of the print unit in the transport direction of the transfer medium, then the introduction of heat into the photoconductor is reliably prevented.

### BRIEF DESCRIPTION OF THE DRAWINGS

This invention is explained in greater detail in view of an exemplary embodiment represented in the drawings, wherein:

FIG. 1 shows a printing device in a schematic representation;

FIG. 2 shows a transfer medium with an associated cooling device, in a schematic representation; and

FIG. 3 shows a transfer medium with interior cooling, in a schematic representation.

### DESCRIPTION OF PREFERRED EMBODIMENTS

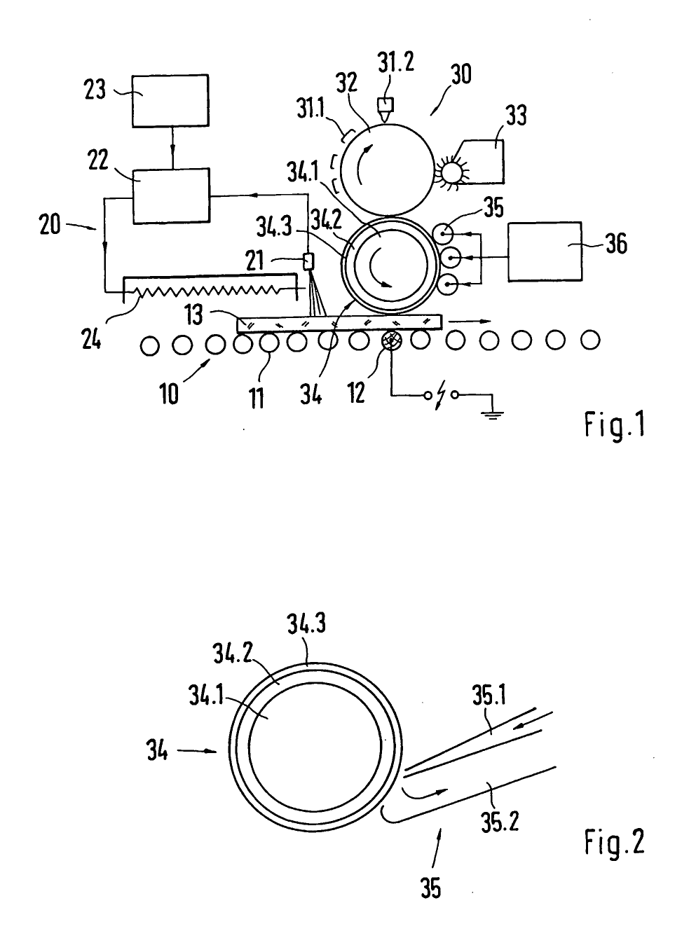

A printing device with an electro-photographic print unit 30 is represented in FIG. 1 and has a cylinder-shaped photoconductor 32 with a uniform charge on a surface in a charge station 31.1. This charge is then partially removed again in a subsequent discharge station 31.2. A developer unit 33 applies toner powder to the charged areas of the surface of the photoconductor. The toner image thus developed is transferred to a transfer medium 34 in a transfer zone. The basic structure of the transfer medium 34 designed as a transfer roller is shown in greater detail in FIG. 2, where the transfer medium 34 has a roller base body 34.1. A resilient, electrically semi-conducting intermediate layer 34.2 is applied to the roller base body 34.1. This can contain, for example, silicon, EPDM or polyurethane. An anti-adhesive coating 34.3 is arranged indirectly or directly above the intermediate layer 34.2 and forms the roller surface.

As FIG. 1 shows, a transport system 10 is arranged below the transfer medium 34 and has a number of roller bodies, on which a substrate 13 can be conveyed. The transport system 10 is arranged so that the transfer medium 34 rolls off on the surface of the substrate 13 to be imprinted. In the process, the toner powder on the transfer medium is transferred to the substrate 13. To assist the toner transfer, a corona 12 is integrated into a roller body of the transport system 10, which is arranged directly underneath the transfer zone.

One or several heating elements 24 each is arranged upstream of the transfer medium in the transport direction of the substrate 13 and acts on the surface of the substrate 13 to heat it evenly to a temperature within the range between 100° C. and 170° C. One or several temperature sensors 21 are arranged between the heating elements 24 and the transfer medium 34 for monitoring the temperature and emit a temperature signal to one or several regulating devices 22. Each regulating device 22 reads in a predetermined value via a control device 23. The predetermined value is compared with the temperature signal in a comparator circuit. The heating elements 24 can be adjusted in the event of a temperature difference. The transport speed of the transport system 10 in the area upstream of the transfer medium 34 can also be regulated. Thus the substrate 13 always enters the transfer zone with an approximately constant surface temperature.

A cooling device 35 is assigned to the transfer medium 34 and has one or several water-cooled rollers, which are in surface contact with the transfer medium 34. The rollers are connected with a heat-regulating unit 36, which removes heat energy from the transfer medium 34. The water coming from the rollers is conducted to the heat-regulating unit 36 via a circulation system and is cooled in the temperature unit 36, and then returned back to the rollers.

A further embodiment of a cooling device 35 is represented in FIG. 2 and has an air supply conduit 35.1. A gaseous cooling medium, preferably air, can be blown through the air supply conduit 35.1 onto the surface of the transfer medium 34. The air removes heat energy from the transfer medium 34. The heated fluid flow can then be aspirated off again via an air-return conduit 35.2. The air-return conduit 35.2 prevents the creation of gas flows outside the cooling zone, which can lead to damage to the toner image maintained on the transfer medium 34 or the photoconductor 32.

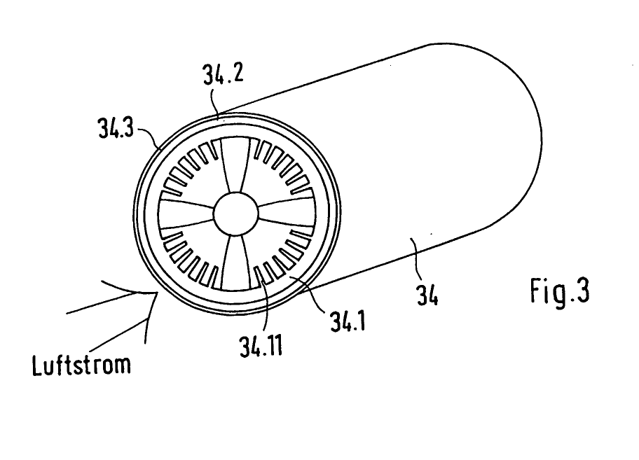

In a further embodiment, the core of the transfer roller can be of a material of good heat conductivity, such as copper, aluminum or ceramic materials, such as SiC or Si3N4, for example, and is possibly provided with cooling ribs, such as represented in FIG. 3, and is cooled by an air flow through the interior of the transfer roller. The core is coated with a flexible material of 1 to 2 mm thickness and of good heat conductivity, such as PTFE, FPM, silicon, or PUR plastic material filled, for example, with glass or a mineral material, for example.

A transfer belt with an interior blower can also be used so that cooling of a large area by a relatively small air flow is possible.

It is advantageous if zone heating is provided over the print width so that the heat output in each of the edge areas is regulated separately from the center zone. This has one advantage, that the surface temperature can be better controlled over the print width and thus the temperature can be constant over the print width and can be improved. Thus, respective individual control devices 22 and temperature sensors 21 are assigned to each zone heating element. In this case the temperature sensors 21 advantageously are of pyrometers which detect the surface temperature of the substrate 13. A temperature constant of ±5 K should be attempted.

A further embodiment provides that the substrates to be imprinted are heated in a separate, upstream-located temperature process. This takes place, for example, in a continuous throughput oven with ambient air heaters.

1. A printing device with an electro-photographic print unit (30) to which a transfer medium (34) for transferring a toner powder to a substrate (13) in a transfer zone is assigned, wherein the substrate (13) can be conducted through the transfer zone by a transport system (10), wherein heat energy can be introduced into the substrate (13) by at least one heating element (24), and a cooling device (35) is assigned to the transfer medium (34) which removes heat from the transfer medium (34), the printing device comprising:
at a transfer zone formed with the substrate (13) the transfer medium (34) having a lower temperature at least in an area of the contact face than at a surface of the substrate (13).

2. The printing device in accordance with claim 1, wherein the cooling device (35) cools the transfer medium (34) to a temperature≦60° C.

3. The printing device in accordance with claim 2, wherein the cooling device (35) cools the transfer medium (34) to a temperature≦40° C.

4. The printing device in accordance with claim 3, wherein the toner transfer in the transfer zone is affected by at least one corona (12).

5. The printing device in accordance with claim 4, wherein the substrate (13) is placed on an electrically conductive base and with respect to a charge of the toner the base is charged with a reverse polarity sign.

6. The printing device in accordance with claim 5, wherein the substrate (13) is moved beyond the transfer medium (34) synchronously with respect to a circumferential speed of the transfer medium (34) by a transport system (10), and a charge with an opposite polarity relative to a second charge of the toner is applied to the transfer medium (34) in the transport system (10).

7. The printing device in accordance with claim 6, wherein on a surface which receives the toner powder the transfer medium (34) has an anti-adhesive layer (34.3), and the anti-adhesive layer (34.3) has a surface energy within a range of 15 mN/m to 30 mN/m.

8. The printing device in accordance with claim 7, wherein the substrate (13) is chargeable with heat energy by at least one heating element designed as at least one of an infrared radiator and a hot air blower by an application of a flame.

9. The printing device in accordance with to claim 8, wherein the substrate (13) to be imprinted is heated to a required temperature in an upstream-located temperature process.

10. The printing device in accordance with claim 9, wherein the heating element (24) heats a surface of the substrate (13) to a surface temperature range between 80° C. and 200° C. at least in certain areas of the surface.

11. The printing device in accordance claim 10, wherein the surface temperature of the substrate (13) is 100° C. to 170° C. at least in certain areas.

12. The printing device in accordance with to claim 9, wherein a temperature sensor (21) is assigned to the substrate (13) and at least one of the heating element (24) and the transport system (10) is controlled by a control device (23) as a function of the signal emitted by the temperature sensor (21).

13. The printing device in accordance with claim 12, wherein a plurality of the temperature sensors (21) are arranged over an entire print width and a heating element (24) is assigned to each of the temperature sensors (21), and a heating output is separately controlled within zones over a print width.

14. The printing device in accordance with claim 13, wherein the temperature sensors (21) each is a pyrometer.

15. The printing device in accordance with claim 14, wherein at least one liquid-cooled contact roller of the cooling device (35) at least one of rolls off on the transfer medium (34) and a climate-controlled air flow is directed onto the surface of the transfer medium.

16. The printing device in accordance with claim 15, wherein the transfer medium (34) is one of a transfer roller and a transfer belt which contains at least a portion of the cooling device (35).

17. The printing device in accordance with claim 16, wherein the transform medium (34) is a transfer roller and has interior air cooling.

18. The printing device in accordance with claim 17, wherein the cooling device (35) removes heat energy from the transfer medium (34) downstream of the transfer zone and upstream of the photoconductor (32) of the print unit (30) in a transport direction of the transfer medium (34).

19. The printing device in accordance with claim 1, wherein the cooling device (35) cools the transfer medium (34) to a temperature≦40° C.

20. The printing device in accordance with claim 1, wherein the toner transfer in the transfer zone is affected by at least one corona (12).

21. The printing device in accordance with claim 1, wherein the substrate (13) is placed on an electrically conductive base and with respect to a charge of the toner the base is charged with a reverse polarity.

22. The printing device in accordance with claim 1, wherein the substrate (13) is moved beyond the transfer medium (34) synchronously with respect to a circumferential speed of the transfer medium (34) by a transport system (10), and a charge with an opposite polarity relative to a second charge of the toner is applied to the transfer medium (34) in the transport system (10).

23. The printing device in accordance with claim 1, wherein on a surface which receives the toner powder the transfer medium (34) has an anti-adhesive layer (34.3), and the anti-adhesive layer (34.3) has a surface energy within a range of 15 mN/m to 30 mN/m.

24. The printing device in accordance with claim 1, wherein the substrate (13) is chargeable with heat energy by at least one heating element designed as at least one of an infrared radiator and a hot air blower, and a blower by an application of a flame.

25. The printing device in accordance with claim 1, wherein the substrate (13) to be imprinted is heated to a required temperature in an upstream-located temperature process.

26. The printing device in accordance with claim 1, wherein the heating element (24) heats a surface of the substrate (13) to a surface temperature range between 80° C. and 200° C. at least in certain areas of the surface.

27. The printing device in accordance with claim 1, wherein a temperature sensor (21) is assigned to the substrate (13) and at least one of the heating element (24) and the transport system (10) is controlled by a control device (23) as a function of the signal emitted by the temperature sensor (21).

28. The printing device in accordance with claim 1, wherein a plurality of the temperature sensors (21) are arranged over an entire print width and a heating element (24) is assigned to each of the temperature sensors (21), and a heating output is separately controlled within zones over a print width.

29. The printing device in accordance with claim 1, wherein temperature sensors (21) arranged over an entire print width each is a pyrometer.

30. The printing device in accordance with claim 1, wherein at least one liquid-cooled contact roller of the cooling device (35) at least one of rolls off on the transfer medium (34) and a climate-controlled air flow is directed onto the surface of the transfer medium.

31. The printing device in accordance with claim 1, wherein the transfer medium (34) is one of a transfer roller and a transfer belt which contains at least a portion of the cooling device (35).

32. The printing device in accordance with claim 1, wherein the cooling device (35) removes heat energy from the transfer medium (34) downstream of the transfer zone and upstream of the photoconductor (32) of the print unit (30) in a transport direction of the transfer medium (34).
